(19) United States
(12) Patent Application Publication
(10) Pub. No.: US 2024/0109127 A1
(43) Pub. Date: Apr. 4, 2024

(54) METAL POWDER FOR MOLD CLADDING AND METAL LAMINATION METHOD USING SAME

(71) Applicants: HYUNDAI MOTOR COMPANY, Seoul (KR); KIA CORPORATION, Seoul (KR)

(72) Inventor: Jin Hyeon Lee, Seongnam-si (KR)

(21) Appl. No.: 18/112,655

(22) Filed: Feb. 22, 2023

(30) Foreign Application Priority Data
Oct. 4, 2022 (KR) 10-2022-0126497

(51) Int. Cl. B22F 10/28; B22F 1/05; B33Y 10/00; B33Y 70/00; C22C 38/02; C22C 38/34; C22C 38/54

(52) U.S. Cl. CPC B22F 10/28; B22F 1/05; B33Y 10/00; B33Y 70/00; C22C 38/02; C22C 38/34; C22C 38/54; B22F 2301/35; B22F 2304/10; B22F 2998/10; B22F 2999/00

(57) ABSTRACT

A metal powder for mold cladding includes, in percent by weight (wt %), 23 to 35% of Ni, 4 to 8% of Cr, 1.1 to 2.8% of Si, 1.3 to 1.5% of B, and the balance of Fe and a metal lamination method using same.

### CROSS REFERENCE TO RELATED APPLICATIONS

This application claims the benefit of priority to Korean Patent Application No. 10-2022-0126497, filed on Oct. 4, 2022 in the Korean Intellectual Property Office, the disclosure of which is incorporated herein by reference.

### TECHNICAL FIELD

The present disclosure relates to a metal powder for mold cladding and a metal lamination method using same.

### BACKGROUND

3D printing techniques, as techniques capable of three-dimensionally manufacturing objects, are methods for manufacturing three-dimensional objects using various laminating methods. Recently, research on the manufacture of materials such as metal parts using 3D printing techniques has been rapidly increased, particularly, attempts have been increased to apply 3D printing techniques to precision parts that require various processing processes.

Conventionally, for maintenance of molds of cast iron, the molds of cast iron are manually overlay-welded at upper parts thereof and mass-processed. However, such methods have a problem in that welding quality considerably varies according to proficiency of welders. In addition, maintenance time of molds increases due to repeated lamination and processing processes, and accordingly it takes a long time for production of final products.

Thus, attempts have recently been made to using 3D printing techniques to obtain quality of maintenance and productivity of molds. The maintenance of molds using 3D printing is performed by a process of melting metal powder and immediately solidifying the molten metal powder. Therefore, the metal powder used for maintenance of the cast iron molds should have a high Ni content to increase adhesion with the cast iron, but Ni is a high-priced element and manufacturing costs increase in the case where the Ni content increases.

Therefore, there is a need to develop a material having a minimized Ni content to lower manufacturing costs while having high productivity by laminating a Fe-based low-alloy material on a case iron mold having a high C content.

### SUMMARY

An aspect of the disclosure is to provide a metal powder for maintenance of a mold by automated overlay welding using a directed energy deposition (DED) method, among 3D printing methods, without conducting a separate processing except for polishing.

Another aspect of the disclosure is to provide a method for laminating a low-priced Fe-based powder and decreasing manufacturing costs by minimizing the content of Ni that is used to increase adhesion with a cast iron to obtain productivity by laminating a Fe-based low alloy material on a cast iron mold having a high C content.

Additional aspects of the disclosure will be set forth in part in the description which follows and, in part, will be obvious from the description, or may be learned by practice of the disclosure.

In accordance with an aspect of the disclosure, a metal powder for mold cladding includes, in percent by weight (wt %), 23 to 35% of Ni, 4 to 8% of Cr, 1.1 to 2.8% of Si, 1.3 to 1.5% of B, and the balance of Fe.

A total weight of Si and B may satisfy 4% or less in the metal powder.

The metal powder may have an average particle diameter D50 of 45 to 125 μm.

The metal powder may include fine powder having particle diameters of 45 μm or less in an amount of 1 wt % or less and coarse powder having particle diameters of 125 μm or more in an amount of 1 wt % or less.

The metal powder may be for directed energy deposition (DED) type 3D printing.

In accordance with another aspect of the present disclosure, a method for laminating a metal includes: preparing a mold base including iron as a main component; preparing the metal powder for mold cladding; and laminating metal by continuously supplying the metal powder for mold cladding onto the mold base and melting the metal powder.

The melting of the metal powder may be performed by emitting a laser beam having an output power of about 1,000 to about 2,000 W.

The emitting of the laser beam may be performed at a moving speed of 600 to 1,200 mm/min.

### BRIEF DESCRIPTION OF THE FIGURES

These and/or other aspects of the disclosure will become apparent and more readily appreciated from the following description of the embodiments, taken in conjunction with the accompanying drawings of which:

FIG. 1 is a diagram illustrating a directed energy deposition (DED) method according to an embodiment of the present disclosure.

FIG. 2A is a photograph of a cross-section of a laminate manufactured using a Fe—Ni—Cr—Si—B-based metal powder according to an embodiment of the present disclosure.

FIG. 2B is a photograph of a cross-section of a laminate manufactured using a Ni-based metal powder (Inconel).

FIG. 2C is a photograph of a cross-section of a laminate manufactured using a Fe low-alloy metal powder.

FIG. 3A is a photograph of cross-sections of laminates manufactured using metal powders respectively including, in an amount of 1 wt % or less, fine powder having particle diameters of 45 μm or less and coarse powder having particle diameters of 125 μm or more.

FIG. 3B is a photograph of cross-sections of laminates manufactured using metal powders respectively including, in an amount of 1 wt % or less, including fine powder having particle diameters of 45 μm or less and coarse powder having particle diameters of 125 μm or more.

FIG. 4A is a photograph of cross-sections of laminates manufactured using metal powders respectively including, in an amount greater than 1 wt %, fine powder having particle diameters of 45 μm or less and coarse powder having particle diameters of 125 μm or more.

FIG. 4B is a photograph of cross-sections of laminates manufactured using metal powders respectively including, in an amount greater than 1 wt %, fine powder having particle diameters of 45 μm or less and coarse powder having particle diameters of 125 μm or more.

### DETAILED DESCRIPTION

Reference will now be made in detail to the embodiments of the disclosure, examples of which are illustrated in the accompanying drawings, wherein like reference numerals refer to like elements throughout. However, the present disclosure may be embodied in many different forms and should not be construed as being limited to the embodiments set forth herein. Rather, these embodiments are provided so that this disclosure will be thorough and complete, and will fully convey the scope of the disclosure to those skilled in the art.

The terms used herein are merely used to describe particular embodiments. Thus, an expression used in the singular encompasses the expression of the plural, unless it has a clearly different meaning in the context. In addition, it is to be understood that the terms such as “including” or “having” are intended to indicate the existence of features, steps, functions, components, or combinations thereof disclosed in the specification, and are not intended to preclude the possibility that one or more other features, steps, functions, components, or combinations thereof may exist or may be added.

Meanwhile, unless otherwise defined, all terms used herein have the same meaning as those commonly understood by one of ordinary skill in the art to which this disclosure belongs. Thus, these terms should not be interpreted in an idealized or overly formal sense unless expressly so defined herein. As used herein, the singular forms are intended to include the plural forms as well, unless the context clearly indicates otherwise.

In addition, the terms “about”, “substantially”, etc. used throughout the specification mean that when a natural manufacturing and substance allowable error are suggested, such an allowable error corresponds a value or is similar to the value, and such values are intended for the sake of clear understanding of the present disclosure or to prevent an unconscious infringer from illegally using the disclosure of the present disclosure.

Cast iron materials, such as FCD550, widely used for molds include a high C content. Thus, in the case where common mold steel materials are laminated using a 3D printing method for maintenance, a risk of occurrence of cracks increases because brilliant structures are formed in interfacial sections of a rapidly cooled structure due to carbon. In addition, a heat affected zone HAZ is overheated by a high output power of a laser beam, thereby increasing a risk of occurrence of micropores and cracks.

Thus, lamination may generally be conducted using a high-priced, Ni-based Inconel material to increase adhesion with the cast iron, but it is difficult to actually apply the Inconel material to the lamination because the use of the high-priced Ni material increases manufacturing costs. Also, in the case of using Ni alone, it is difficult to obtain strength at the level of conventional mold steels, so that the lifespan of molds may decrease.

In order to solve the above-described problems, the present disclosure provides a metal powder for mold cladding having high adhesion with cast iron and including a Fe-based alloy, as a base, applicable to 3D printing processes as a base.

A metal powder for mold cladding according to an embodiment of the present disclosure is a Fe—Ni—Cr—Si—B-based metal powder including Fe, Ni, Cr, Si, and B. Specifically, the metal powder for mold cladding may include, in percent by weight (wt %), 23 to 35% of Ni, 4 to 8% of Cr, 1.1 to 2.8% of Si, 1.3 to 1.5% of B, and the balance of Fe.

Hereinafter, reasons for numerical limitations on the contents of alloying elements in the embodiment of the present disclosure will be described in detail. In the following descriptions, the unit is wt % unless otherwise stated.

The content of nickel (Ni) is from 23 to 35 wt %. Ni as an effect on preventing occurrence of cracks by increasing diffusion of carbon (C) in cast iron by increasing stability of interfacial sections. An upper limit of the Ni content is controlled to 35% to prevent occurrence of cracks caused by cooling and shrinkage of powder. In addition, a lower limit of the Ni content is controlled to 23 wt % to minimize variation of thermal expansion coefficient and prevent a decrease in adhesion with cast iron.

The content of chromium (Cr) is from 4 to 8 wt %. Cr serves to obtain abrasion resistance and reinforce rigidity of laminated materials by alloying. When Cr is not added, a surface hardness is about 120 Hv making it difficult to obtain rigidity. When the Cr content satisfies the range of 4 to 8 wt %, rigidity is sufficient to satisfy a surface hardness of about 600 Hv or more, and the metal powder may be applied to a camshaft material conventionally used to obtain high abrasion resistance and high rigidity. When the Cr content exceeds 8 wt %, hardness, relative to a target value, may decrease due to an excessive austenite phase in the case where carbon diffuses in cast iron, and there is a high possibility of occurrence of surface cracks due to generation of an oxide and a change in expansion coefficient.

In the case of silicon (Si) and boron (B), addition of small amounts thereof may prevent overheating of the heat affected zone HAZ in interfacial sections to inhibit thermal expansion and rapid cooling, thereby increasing adhesion with cast iron.

The content of silicon (Si) is from 1.1 to 2.8 wt %. When added in a small amount of 1.1 to 2.8%, Si has an effect on preventing thermal expansion and rapidly cooling by inhibiting overheating of the heat affected zone.

The content of boron (B) is from 1.3 to 1.5 wt %. When added in a small amount of about 1.4%, B has an effect on increasing hardenability, and the B content is adjusted by 0.1%, if necessary.

In addition, a total weight of Si and B may be 4 wt % or less. When the total weight of Si and B is greater than 4 wt %, surface cracks may occur depending on generation of an oxide and rapid cooling conditions due to a change in expansion coefficients.

The remaining element of the present disclosure is iron (Fe). However, unintended impurities may inevitably be incorporated from raw materials or surrounding environments during common manufacturing processes, and thus addition of other alloying elements is not excluded. Theses impurities are known to any person skilled in the art of manufacturing and details descriptions thereof are not specifically given in the present disclosure.

The metal powder for mold cladding according to the present disclosure may be metal powder for 3D printing. As 3D printing techniques, directed energy deposition (DED), powder bed fusion (PBF), binder jetting (BJ) methods, and the like may be used. In the present disclosure, directed energy deposition (DED) 3D printing method may be used.

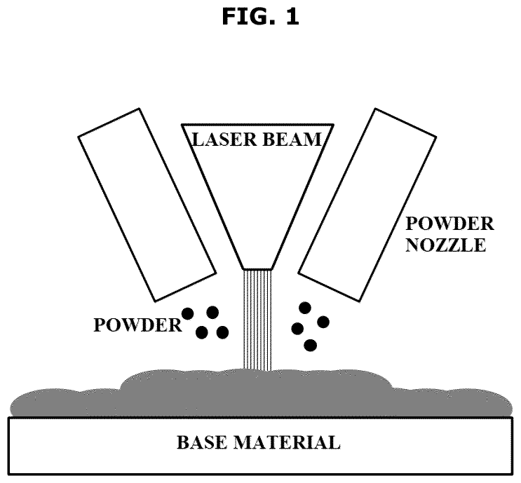

Specifically, as shown in FIG. 1, the directed energy deposition (DED) method is a 3D printing method used to manufacture a product by supplying a metal powder onto a base material and melting the metal powder by emitting a high output power laser beam thereto simultaneously. Specifically, immediately after forming a molten pool on the surface of the base material by emitting a laser beam, the metal powder is supplied. The DED method facilitates lamination of hetero-materials and is suitable for high-rigidity and large-sized parts, and thus this method is mainly used to repair molds and tools. Among the 3D printing methods, the DED method capable of laminating materials on large-sized cast iron molds is the most suitable method for the metal powder according to the present disclosure.

The metal powder for mold cladding according to an embodiment of the present disclosure may have an average particle diameter D50 of 45 to 125 μm. The particle diameters of the metal powder for mold cladding are controlled in the range of 45 to 125 μm to prevent formation of a non-molten region and reduce occurrence of segregation.

Specifically, unlike other 3D printing processes, the DED process is considerably affected by the amounts of fine powder and coarse powder.

In the metal powder for mold cladding according to an embodiment of the present disclosure, the amount of the fine powder having particle diameters of 45 μm or less may be controlled to 1 wt % or less. As the amount of the fine powder having particle diameters of 45 μm or less increases, non-molten regions may be formed in some areas, which are not under the influence of the laser beam, and thus segregation occurs in the structure, resulting in a decrease in strength and formation of micropores. Also, when the melting is conducted by emitting a laser beam, excessive sparks and scattered powder may contaminate a lens of the laser to form non-molten regions, resulting in a decrease in processing speed and formation of micropores.

In the metal powder for mold cladding according to an embodiment of the present disclosure, the amount of the coarse powder having particle diameters of 125 μm or more may be controlled to 1 wt % or less. As the amount of the coarse powder having particle diameters of 125 μm or more increases, a flow of carrier gas is hindered while powder is supplied to cause non-uniform supply, thereby forming coarse pores.

A metal lamination method according to an embodiment of the present disclosure includes: preparing a mold base (base material) including iron as a main component; preparing the metal powder for mold cladding according to the present disclosure; and laminating metal by continuously supplying the metal powder for mold cladding onto the mold base and melting the metal powder.

The descriptions given above about the metal powder for mold cladding may also be applied to the metal lamination method according to the present disclosure. Although redundant descriptions on substantially the same configurations are omitted, the omitted descriptions may equally be applied thereto.

In lamination of a single material by the DED process as shown in FIG. 1, it is important to control the output power of the laser and the moving speed of the head. When the metal powder is laminated for maintenance of a mold, lamination conditions may be changed according to a position of the mold, a shape of a curved portion, and components of a base material.

According to an embodiment of the present disclosure, the melting of the metal powder may be performed by emitting a laser beam having an output power of about 1,000 to about 2,000 W. In addition, the emitting of the laser beam may be conducted at a moving speed of about 600 to about 1,200 mm/min. In the case where these conditions are satisfied, pores may not be formed after lamination of metal, an area of the heat affected zone HAZ may be small, and cracks may not occur in the interfacial sections.

Hereinafter, the present disclosure will be described in more detail through examples. However, these examples are made only for illustrative purposes, and the present disclosure is not to be construed as being limited to those examples.

### EXAMPLE

For comparison between alloying elements according to the present disclosure and alloying elements used for conventional maintenance of molds, a Fe—Ni—Cr—Si—B-based metal powder (Example 1) satisfying the composition of alloying elements according to the present disclosure, a Ni-based metal powder (Inconel; Comparative Example 1) and a Fe-based low-alloy metal powder (Comparative Example 2) were prepared. The detailed compositions of alloying elements thereof are shown in Table 1 below.

TABLE 1
(Unit: wt %)

| | C | Si | Mn | Cr | Mo | Ni | B | Fe |
|---|---|---|---|---|---|---|---|---|
| Example 1 | trace | 1.95 | — | 6.00 | — | 28.0 | 1.4 | the balance |
| | amount | | | | | | | |
| Comparative | 0.30 | 2.80 | — | 7.00 | — | 85.18 | 1.30 | the balance |
| Example 1 | | | | | | | | |
| Comparative | 0.30 | 0.22 | 0.77 | 1.10 | 0.23 | — | — | the balance |
| Example 2 | | | | | | | | |

### Experimental Example 1: Evaluation of Lamination According to Types of Metal Powder

To evaluate lamination properties of the metal powders of Example 1 and Comparative Examples 1 and 2, lamination was conducted on a base material FCD 550 under the same processing conditions shown below by only changing types of metal powder.

<Metal Lamination Process Conditions>
laser output power: 1,000 W
head moving speed: 750 mm/min
carrier gas supply speed: 3 L/min
shield gas supply speed: 6 L/min
input of powder: 10 g/min

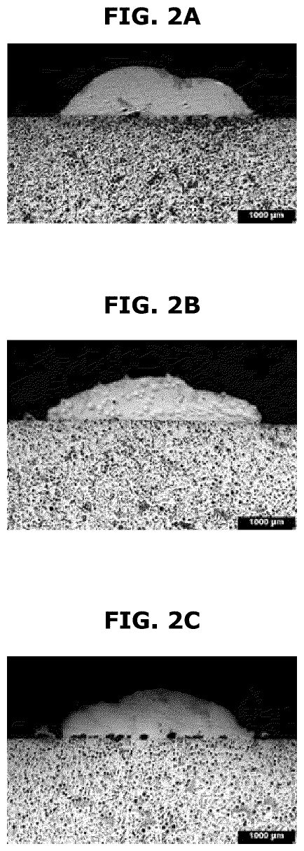

FIGS. 2A to 2C are photographs of cross-sections of laminated metals. Specifically, FIG. 2A shows a cross-section obtained using a Fe—Ni—Cr—Si—B-based metal powder of Example 1, FIG. 2B shows a cross-section obtained using a Ni-based metal powder (Inconel) of Comparative Example 1. FIG. 2C shows a cross-section obtained using a Fe low-alloy metal powder of Comparative Example 2.

Referring to FIG. 2B, many micropores were formed in the case of using the Ni-based metal powder of Comparative Example 1. Referring to FIG. 2C, adhesion with the base material was not sufficient in the case of using the Fe low-alloy metal powder of Comparative Example 2. On the contrary, referring to FIG. 2A, in the case of using the Fe—Ni—Cr—Si—B-based metal powder of Example 1 according to the present disclosure, it was confirmed that adhesion with the based material was excellent without forming micropores.

### Experimental Example 2: Evaluation of Lamination According to Particle Diameter of Metal Powder

In order to evaluate lamination according to particle diameter of the Fe—Ni—Cr—Si—B-base metal powder of the Example 1, metal powders respectively including, in an amount of 1 wt % or less, fine powder having particle diameters of 45 μm or less and coarse powder having particle diameters of 125 μm or more, and metal powders respectively including, in an amount greater than 1 wt %, fine powder having particle diameters of 45 μm or less and coarse powder having particle diameters of 125 μm or more were laminated.

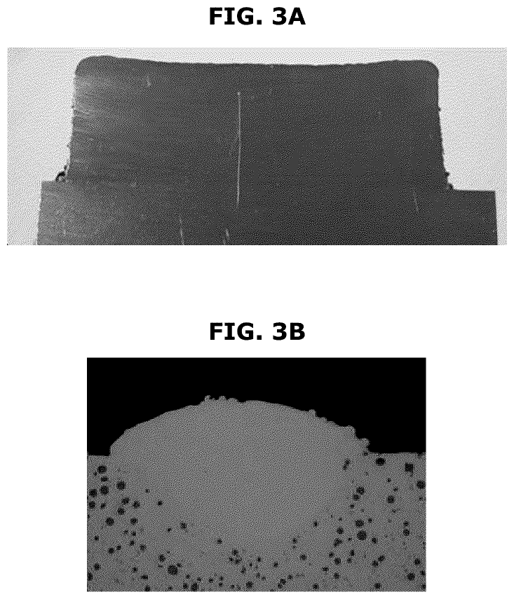

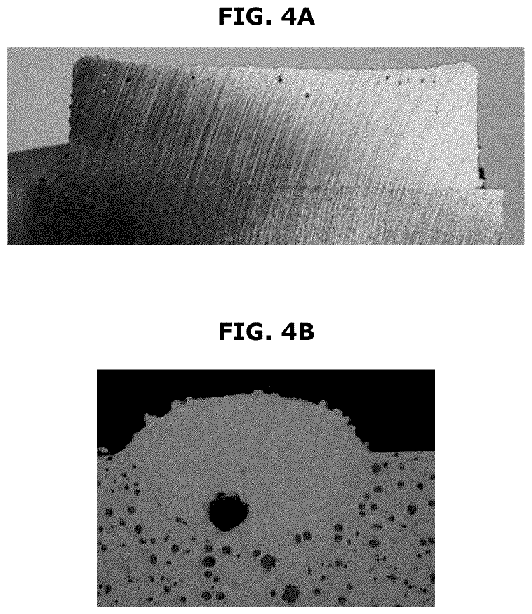

FIGS. 3A and 3B are photographs of cross-sections of laminates obtained using metal powders respectively including, in an amount of 1 wt % or less, fine powder having particle diameters of 45 μm or less and coarse powder having particle diameters of 125 μm or more. FIGS. 4A and 4B are photographs of cross-sections of laminates obtained using metal powders respectively including, in an amount greater than 1 wt %, including fine powder having particle diameters of 45 μm or less and coarse powder having particle diameters of 125 μm or more.

Referring to FIGS. 3A to 4B, it was confirmed that while pores were not formed in the case of using the metal powders respectively including, in an amount of 1 wt % or less, fine powder having particle diameters of 45 μm or less and coarse powder having particle diameters of 125 μm or more, pores were formed in the case of using the metal powders respectively including, in an amount greater than 1 wt %, fine powder having particle diameters of 45 μm or less and coarse powder having particle diameters of 125 μm or more.

### Experimental Example 3: Evaluation of Lamination According to Processing Conditions

In the DED method, it is important to control the output power of the laser and the moving speed of the head. Thus, in this experiment, the metal powders were laminated on mass-produced molds by applying different head moving speeds and different output powers, as controllable conditions, and the evaluation was conducted based on interfacial sections between the laminated portion and the base material under each condition.

Lamination of the metal powder for maintenance of a mold, lamination is performed while changing lamination conditions in accordance with a position of the mold, a shape of a curved portion, and components of the base material. Accordingly, because lamination should be performed under conditions other than the conventional specific parameters, ranges enabling lamination of each powder were evaluated.

The head moving speed and the laser output power are factors affecting heat input that is an important value during lamination, and a minimum heat input enabling lamination on the base material FCD 550 may be calculated, and therefore, appropriate parameter ranges may be determined.

<Metal lamination process conditions>
laser output power: 1,000 to 2,000 W
head moving speed: 600 to 1,200 mm/min
carrier gas supply speed: 3 L/min
shield gas supply speed: 6 L/min
input of powder: 10 g/min

<Evaluation Criteria>

In Table 2 below, after metal lamination, a case satisfying all of the following conditions was evaluated as ∘, a case satisfying one or two of the following conditions was evaluated as Δ, and a case not satisfying any of the following conditions was evaluated as X.
no pore on a cross-section
small area of heat affected zone HAZ
no crack in interfacial section

TABLE 2

| Moving | | | | | | |
|---|---|---|---|---|---|---|
| speed | Type of | Output power | | | | |
| (mm/min) | metal powder | 1,000 W | 1,250 W | 1,500 W | 1,750 W | 2,000 W |
| 600 | Example 1 | ◯ | ◯ | ◯ | ◯ | ◯ |
| | Comparative | Δ | Δ | Δ | Δ | Δ |
| | Example 1 | | | | | |
| | Comparative | X | X | X | X | X |
| | Example 2 | | | | | |
| 750 | Example 1 | ◯ | ◯ | ◯ | ◯ | ◯ |
| | Comparative | Δ | Δ | Δ | Δ | Δ |
| | Example 1 | | | | | |
| | Comparative | X | X | X | X | X |
| | Example 2 | | | | | |
| 900 | Example 1 | ◯ | ◯ | ◯ | ◯ | ◯ |
| | Comparative | Δ | Δ | Δ | Δ | Δ |
| | Example 1 | | | | | |
| | Comparative | X | X | X | X | X |
| | Example 2 | | | | | |
| 1,050 | Example 1 | ◯ | ◯ | ◯ | ◯ | ◯ |
| | Comparative | Δ | Δ | Δ | Δ | Δ |
| | Example 1 | | | | | |
| | Comparative | X | X | X | X | X |
| | Example 2 | | | | | |
| 1,200 | Example 1 | ◯ | ◯ | ◯ | ◯ | ◯ |
| | Comparative | Δ | Δ | Δ | Δ | Δ |
| | Example 1 | | | | | |
| | Comparative | X | X | X | X | X |
| | Example 2 | | | | | |

According to an embodiment of the present disclosure, productivity may be obtained via maintenance by laminating a Fe-based low-alloy material on a cast iron mold having a high C content and manufacturing costs may be reduced by minimizing the content of Ni that is used to increase adhesion with the cast iron material.

Also, a mold may be maintained by automated overlay-welding using a 3D printing method using the metal powder according to the present disclosure without performing separate processing.

However, the effects obtainable by the present disclosure are not limited to the aforementioned effects, and any other effects not mentioned herein will be clearly understood from the following description by those skilled in the art to which the present disclosure pertains.

Although embodiments of the disclosure have been shown and described, it would be appreciated by those having ordinary skill in the art that changes may be made in these embodiments without departing from the principles and spirit of the disclosure, the scope of which is defined in the claims and their equivalents.

1. A metal powder for mold cladding comprising, in percent by weight, 23 to 35% of Ni, 4 to 8% of Cr, 1.1 to 2.8% of Si, 1.3 to 1.5% of B, and the balance of Fe;
wherein the metal powder has an average particle diameter D50 of 45 to 125 μm; and
wherein the metal powder comprises fine powder having particle diameters of 45 μm or less in an amount of 1 wt % or less and coarse powder having particle diameters of 125 μm or more in an amount of 1 wt % or less.

2. The metal powder according to claim 1, wherein a total weight of Si and B satisfies 4% or less in the metal powder.

3-4. (canceled)

5. The metal powder according to claim 1, wherein the metal powder is for directed energy deposition 3D printing.

6. A method for laminating a metal, the method comprising:
preparing a mold base including iron as a main component;
preparing the metal powder for mold cladding according to claim 1; and
laminating metal by continuously supplying the metal powder for mold cladding onto the mold base and melting the metal powder.

7. The method according to claim 6, wherein the melting of the metal powder is performed by emitting a laser beam having an output power of 1,000 to 2,000 W.

8. The method according to claim 7, wherein the emitting of the laser beam is performed at a moving speed of 600 to 1,200 mm/min.
